(19) United States
(12) Patent Application Publication
(10) Pub. No.: US 2008/0069957 A1
(43) Pub. Date: Mar. 20, 2008

(54) METHOD OF MANUFACTURING METAL FILM PATTERN FORMING BODY

(75) Inventors: Jae Suk SUNG, Gyunggi-do (KR); Gi Lyong Na, Gyunggi-do (KR); Ick Chang Choi, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/835,767

(22) Filed: Aug. 8, 2007

(30) Foreign Application Priority Data
Sep. 15, 2006 (KR) 10-2006-89426

(51) Int. Cl. B05D 3/10

(52) U.S. Cl. 427/305; 427/301

(57) ABSTRACT

A method of manufacturing a metal film pattern forming body, the method including: forming a desired metal film pattern on one surface of a stamp by using a catalyst for activating a surface of a plastic base; activating the surface of the plastic base by transferring the catalyst formed on the surface of the stamp onto the surface of the plastic base; and plating the surface of the activated plastic base.

### CROSS-REFERENCE TO RELATED APPLICATIONS

This application claims the priority of Korean Patent Application No. 2006-89426 filed on Sep. 15, 2006, in the Korean Intellectual Property Office, the disclosure of which is incorporated herein by reference.

### BACKGROUND OF THE INVENTION

1. Field of the Invention

The present invention relates to a method of forming a metal film, and more particularly, to a method of forming a metal film by plating a surface of a plastic base.

2. Description of the Related Art

Recently, with increasingly smaller size in a mobile telecommunication terminal, the terminal has tended to employ an interior antenna in place of a conventional exterior antenna. Also, various functions added to the terminal have essentially called for development of the interior antenna capable of responding to a new frequency band.

In a conventional interior antenna, a metal plate is attached onto a plastic base and a radiator of the antenna is implemented by adjusting a pattern shape of the metal plate. In this conventional technique, the metal plate is fabricated by a press die, thus high in costs and not automated when assembled together with other parts.

Lately, the metal plate-based technique has given way to a molded interconnected device technique (MID) of directly plating a surface of a plastic base. However, this method necessitates a dual die for dual injection molding, thereby increasing costs and posing a difficulty to development.

FIG. 1 is a cross-sectional view illustrating a method of manufacturing an antenna by conventional dual injection.

Referring to FIGS. 1A through 1C, first, a desired pattern of the antenna is embossed by injection-molding a platable resin 11. Then, a non-platable resin 12 is injection-molded to expose an embossed portion of the pattern of the platable resin 11. Subsequently, a plating layer 13 is formed on the exposed portion of the platable resin 11 to form the antenna pattern.

When two heterogeneous resins are injection-molded, as described above, one resin is platable on plastic and another resin is not platable on the plastic.

Here, the exposed portion of the platable resin 11 is rendered platable. Thus, when an injection molding subjected to dual injection is plated, the plating layer 13 is selectively formed only on the exposed portion of the platable resin 11. FIG. 1B is the most important of the above processes. Specifically, an exact portion for plating should be exposed to ensure only a desired portion to be plated. This entails another injection-molding to be performed for the unplated portion, thus necessitating a pair of dies. In this dual injection-molding, the resin injected at the second time may flow to an undesired area, thereby preventing only the desired area from being plated. This may bring about a change in a plated pattern shape of the antenna.

Therefore, this dual injection-molding requires dies with highly precise embossment/depression, thus increasing costs. Also, in a case where defects occur in the antenna, the dies should be completely corrected. Furthermore, the antenna characteristics should be necessarily tuned in a development process. However, in a case where the antenna needs a change in shape for antenna tuning, the dies for injection-molding should be changed.

### SUMMARY OF THE INVENTION

An aspect of the present invention provides a method of plating a metal film, in which a plastic base is formed by a single injection-molding in place of a dual injection-molding and the plastic base is directly plated with a desired pattern of the metal film.

According to an aspect of the present invention, there is provided a method of manufacturing a metal film pattern forming body, the method including: forming a desired metal film pattern on one surface of a stamp by using a catalyst for activating a surface of a plastic base; activating the surface of the plastic base by transferring the catalyst formed on the surface of the stamp onto the surface of the plastic base; and plating the surface of the activated plastic base.

The forming a catalyst on a surface of the stamp may include: printing the desired metal film pattern with a liquid catalyst; drying the printed catalyst to have a certain viscosity; and transferring the dried catalyst pattern onto the stamp.

The catalyst may have a certain viscosity to maintain a desired pattern during the transferring process.

The catalyst may be formed of a material attachable onto the surface of the plastic base where the catalyst is transferred and capable of forming a plating layer on the surface of the plastic base. The catalyst may be formed of an ABS-based resin.

The stamp may have a certain hardness to be stamped on a three-dimensional surface. The stamp may be formed of a silicone rubber.

The plastic base may be one of a base of an internal antenna, the base formed of poly carbonate, a carrier film and a case of a mobile telecommunication terminal.

The plating may include electroless plating using a copper ion.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A to 1C are cross-sectional views illustrating a method of forming a metal film by a conventional dual injection-molding;

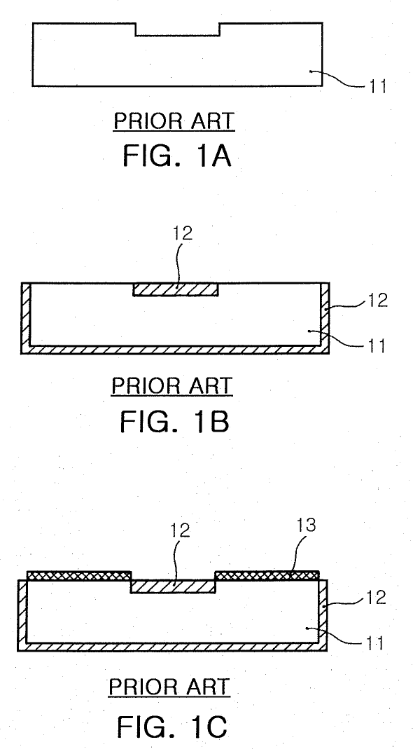

FIGS. 2A to 2D illustrate a method of manufacturing a metal film pattern forming body according to an exemplary embodiment of the invention;

FIGS. 3A to 3D illustrate a method of manufacturing a metal film pattern forming body having a bending according to an exemplary embodiment of the invention;

FIG. 4 is a perspective view illustrating an internal antenna for a mobile telecommunication terminal according to an exemplary embodiment of the invention; and

FIG. 5 is a plan view illustrating an antenna and an electromagnetic wave shielding layer disposed in a case of a mobile telecommunication terminal according to an exemplary embodiment of the invention.

### DETAILED DESCRIPTION OF THE PREFERRED EMBODIMENT

Exemplary embodiments of the present invention will now be described in detail with reference to the accompanying drawings.

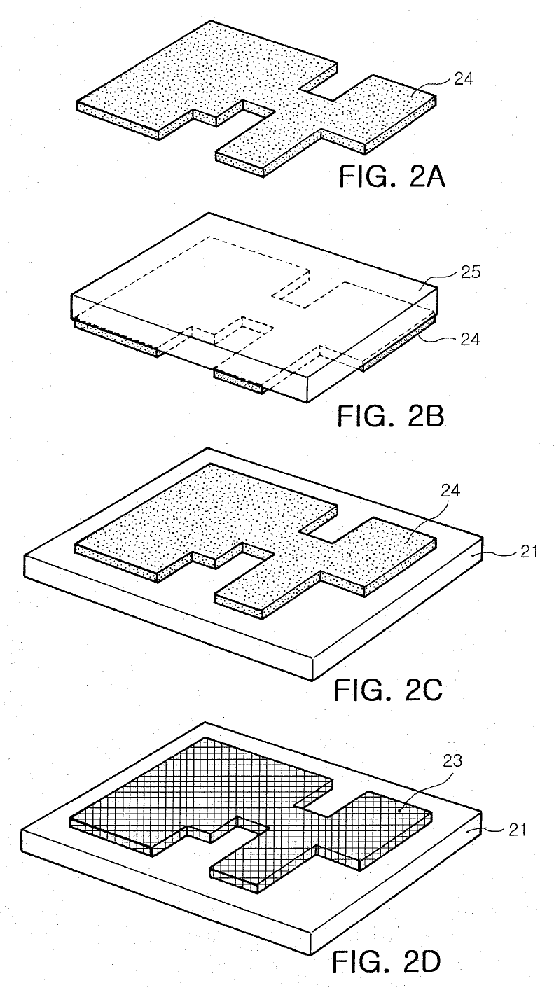

FIGS. 2A to 2D illustrate a method of manufacturing a metal film pattern forming body having a plated conductive film formed on a plastic base according to an exemplary embodiment of the invention.

Referring to FIG. 2A, a desired antenna pattern is formed using a catalyst.

The catalyst 24 chemically reacts with the plastic base on a surface of the plastic base to activate the surface of the plastic base, thereby allowing the surface of the plastic base to be metal-plated directly. Therefore, the catalyst 24 in the present embodiment may contain elements of chemically modifying a plastic base and elements of adsorbing a plating solution.

The elements of modifying the plastic base may vary with the type of modification. Specifically, in a case where chemical modification is hydrolysis modification, alkaline materials such as sodium hydroxide, potassium hydroxide, ammonia, and amines may be employed. Alternatively, in a case where chemical modification is hydrolysis modification and oxidative modification, organic acids such as hydrochloric acid, sulfuric acid, chromic acid, and acetic acid may be utilized.

A catalyst in electroless plating reaction may adopt palladium, silver, copper, platinum, iron, and nickel in a case where a phosphorous acid reducing agent is used as an electroless plating solution. Therefore, the catalyst containing the metal elements and chemical elements as described is applicable.

The catalyst 24 may employ a paint well-deposited on one of a thermoplastic resin and a thermosetting resin, and plated well. Particularly, an ABS resin-based paint may be adopted. The ABS resin-based paint activates the surface of the plastic base, thereby forming a catalytic layer for adsorbing a plating solution.

According to the present embodiment, the catalyst 24, which is a solvent for ABS resin, is formed by diluting a paint obtained by dissolving and liquefying methylethyl ketone, ethyl acetate, and kocosol, printing the liquefied paint on an additional plate and drying the same.

According to the present embodiment, the catalyst 24 has a certain shape. The catalyst 24 is identical in shape to a metal film pattern to be formed on the plastic base. To form the catalyst 24 in a desired shape of the metal film pattern, the catalyst 24 has a certain viscosity. Such viscosity ensures the metal film pattern to be formed precisely as the catalyst and to be transferred later while maintaining the shape of the pattern.

The catalyst with this viscosity may be formed by printing. Materials for the catalyst are dissolved to be printed on an additional plate, and then dried until the printed catalyst retains a certain viscosity.

Referring to FIG. 2B, the catalyst formed is transferred onto a stamp.

This process may be carried out by stamping the stamp 25.

The catalyst 24 patterned by the stamping should be attached on one surface of the stamp 25. Thus, the stamp 25 needs to be adhered to the catalyst 24 in a certain extent.

The stamp 25 serves to transfer the catalyst 24 onto the plastic base 21. Thus, an adhesive force between the stamp 25 and the catalyst 24 should be smaller than an adhesive force between the catalyst 24 and the plastic base 21.

To control an adhesive force between the stamp 25 and the catalyst 24 and between the catalyst 24 and the plastic base 21, adhesive materials with different adhesive forces may be applied on an interface between the stamp 25 and the catalyst 24 and an interface between the catalyst 24 and the plastic base 21, respectively.

The stamp 25 does not chemically react with the catalyst 24 and may be formed of a material with a certain hardness to be stamped on a three-dimensional plastic base 21.

The stamp 25 may be formed of a silicon rubber.

The stamp 25 may be manufactured by using two different materials. That is, a portion of the stamp 25 adhered to the catalyst 24 and contacting the plastic base 21 may be formed of a material, such as silicone rubber, which is bendable along a surface of the plastic base 21. A top of the stamp 24 may be formed of a hard metal material to facilitate stamping.

Referring to FIG. 2C, the catalyst formed on the stamp is transferred onto the plastic base.

The stamp 25 having the catalyst 24 formed thereon is stamped on the plastic base 21 and the stamp 25 is removed. With the stamp removed, the plastic base 21 and the catalyst 24 are adhered together.

The catalyst 24 transferred chemically modifies the surface of the plastic base 21, thereby allowing a metal plating layer to be formed on the plastic base.

To enable the catalyst 24 formed on the stamp 25 to be transferred onto the plastic base 21, an adhesive force between the catalyst 24 and the plastic base 21 should differ from an adhesive force between the catalyst 24 and the stamp 25. In this fashion, difference in adhesive forces at interfaces of different materials ensures easier stamping.

The catalyst 24 is transferred onto the stamp 24 (shown in FIG. 2B) and the catalyst 24 is transferred onto the plastic base 21 (shown in FIG. 2C), thereby using the catalyst 24 as a metal film on the plastic base 21, without a change in the shape of the catalyst 24 initially formed.

That is, in order to obtain a desired antenna radiator, the catalyst is printed in a desired shape of the antenna radiator and the printed catalyst is dried to have a certain viscosity. Then, the catalyst is transferred onto an antenna base by stamping.

The antenna manufacturing process necessarily entails tuning. Thus, the catalyst formed in the shape of the antenna radiator is beneficial since only the shape of the catalyst needs to be adjusted to control the antenna pattern. That is, the pattern is easily correctable by correcting only a metal mask of the pattern stamped, thereby dramatically reducing developmental period and costs.

In the case of a conventional dual injection-molding, dies for the injection-molding should be changed, thus incurring huge costs. However, according to the present embodiment, a relatively simple process assures the same effects.

In the present embodiment, materials for the plastic base 21 are not limited but may vary with use of the metal film pattern forming body of the present embodiment as long as a plating layer is hardly formable on the surface of the plastic base 21 and the materials for the surface thereof are chemically modifiable due to the catalyst 24.

The plastic base 21 may be formed of one of polyester, poly acrylate, and poly carbonate.

The present embodiment may be varied according to the material and type of the plastic base 21.

In a case where the plastic base 21 is an antenna base of an internal antenna of a mobile telecommunication terminal, the plating layer formed on the plastic base may serve as a radiator of the internal antenna.

The plastic base 21 may be a thin carrier film for use in the internal antenna. To produce the internal antenna, a desired antenna pattern is formed on the carrier film by plating and the carrier film having the antenna pattern formed thereon is adhered onto one surface of a case of the mobile telecommunication terminal by in-mold labeling.

The plastic base 21 may be the case of the mobile telecommunication terminal. Here, the antenna pattern is formed directly on an inner surface of the case of the mobile telecommunication terminal.

Referring to FIG. 2D, the plating layer is formed on the surface of the plastic base activated by the catalyst.

According to the present embodiment, the plating layer 23 may be formed by electroless plating.

The plating layer 23 may be electrolessly plated by appropriately selecting a metal such as Ni, Cu, Au, Co, Pd and alloys thereof. For example, alloys of the Ni include NiP, NiSnP, NiWP and NiWB.

It is hard to directly plate the surface of the plastic base formed of poly carbonate. But according to the present embodiment, the catalyst 24 with a desired shape is attached on the surface of the plastic base 21 and the catalyst 24 reacts with the surface of the plastic base, thereby modifying the surface of the plastic base to be platable.

According to the present embodiment, to carry out electroless plating, an electroless plating solution including cupric sulfate is prepared and the plastic base is immersed therein to form a plating layer.

The electroless plating ensures easy formation of the metal film having a minute pattern.

Moreover, with the electroless plating layer acting as a conductive film, one of a homogeneous metal layer and a heterogeneous metal layer with respect to the electroless plating layer may be formed on the conductive layer by electroplating.

The plating layer 23 formed on the plastic base 21 may be utilized as a radiator and an electromagnetic wave shielding layer of an internal antenna according to various embodiments.

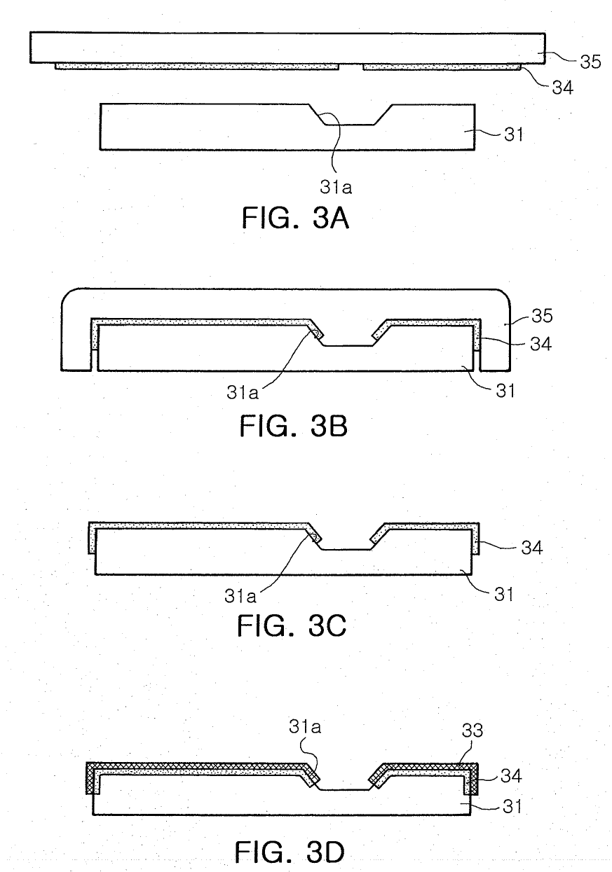

FIGS. 3A through 3D illustrate a method of manufacturing a metal film pattern according to an exemplary embodiment of the invention.

Referring to FIGS. 3A through 3D, a catalyst 34 is formed on a three-dimensional plastic base 31 to form a plating layer 33.

The stamp 35 may have a certain hardness to be varied in shape according to a shape of the plastic base 31.

According to the present embodiment, the stamp 35 may be formed of a silicon rubber variable in shape according to the shape of the plastic base 31.

To form the catalyst 34 formed on a bottom of the stamp 35 on not only a top but also sides of the plastic base 31, the catalyst 34 has a length greater than a length of the top of the plastic base.

To form the catalyst 34 on the bottom of the stamp 35, a liquid catalyst is directly printed and dried on the stamp 35.

Particularly, the catalyst is printed with a uniform pattern on an additional plate and dried to have a certain viscosity and the stamp 35 is stamped. With this process, the catalyst is formed in an identical shape to a desired metal pattern.

In stamping the stamp with the catalyst 34 formed thereon on the plastic base 31, the stamp 35 may have a shape varied according to a shape of the top of the plastic base 31.

The stamp 35 may be formed of a silicone rubber variable in shape according to the shape of the plastic base as described above.

Therefore, the catalyst 34 may be solidly bonded onto not only the top of the plastic base 31 but also the sides and an inclined surface of the plastic base 31.

The catalyst 34 bonded in this fashion activates a certain portion of the plastic base 31, thereby rendering the activated portion of the plastic base platable.

The plastic base 31 having the catalyst-activated portion thereon is immersed in a plating solution to plate only the activated portion.

This process allows a metal film to be formed on the three-dimensional plastic base. Thus, the metal film, when employed in the internal antenna, may serve as a radiator of the antenna on the top of the plastic base and the feeder and ground of the antenna on the sides of the plastic base.

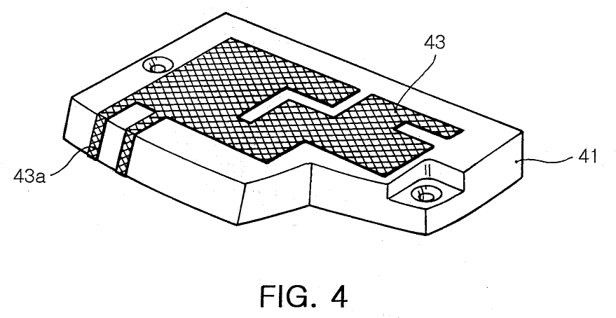

FIG. 4 is a perspective view illustrating an antenna base having a metal film pattern formed thereon according to an exemplary embodiment of the invention.

Referring to FIG. 4, a metal film pattern 43 is formed on a base of an internal antenna having a three-dimensional shape.

According to the present embodiment, the antenna radiator 43 is formed on the base 41 of the antenna composed of poly carbonate.

The antenna base 41 has a three-dimensional shape with a bending. A radiator 43 is formed on a top of the antenna base and a feeding terminal 43a is formed on a side of the antenna base.

To manufacture the internal antenna, a catalyst including the radiator 43 and the feeding terminal 43a of the antenna may be formed and transferred onto the antenna base 41, and the antenna base 41 may be plated in the shape of the catalyst.

The radiator 43 may be configured variously and extended not only to the top of the antenna base 41 but also to the sides thereof.

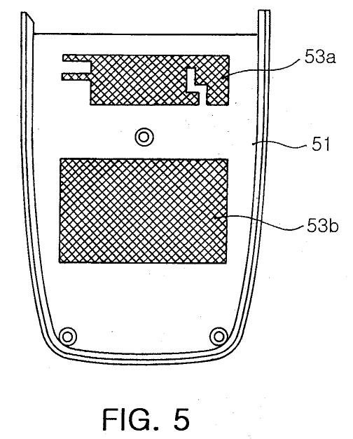

FIG. 5 is a perspective view illustrating an antenna pattern and an electromagnetic wave shielding layer formed inside a case of a mobile telecommunication terminal according to an exemplary embodiment of the invention.

According to the present embodiment, the antenna pattern 53a and the electromagnetic wave shielding layer 53b are formed concurrently inside a case 51 of the mobile telecommunication terminal.

The mobile telecommunication terminal may be reduced in size chiefly by enabling the antenna to be mounted in a minimal space. Thus, to assure a small-sized terminal, the antenna pattern 53a may be directly formed on the case 51 of the mobile telecommunication terminal.

Also, in general, an additional electromagnetic wave shielding layer is disposed to shield electromagnetic waves from wireless devices inside the mobile telecommunication terminal. The electromagnetic wave shielding layer 53b formed in the case of the mobile telecommunication terminal as described above reduces a mounting space and simplifies a manufacturing process. The electromagnetic wave shielding layer 53b may be connected to a ground on a printed circuit board of the mobile telecommunication terminal.

Here, two different patterns may be formed as catalysts. Then, the catalysts may be transferred into the case of the mobile telecommunication terminal, respectively, using at least one stamp, thereby activating an internal surface of the mobile telecommunication terminal.

The activated surface may be electrolessly plated to form an antenna pattern 53a and electromagnetic wave shielding layer 53b of the mobile telecommunication terminal. Plating layers such as the antenna pattern 53a and the electromagnetic wave shielding layer 53b may be formed using different plating materials, respectively.

This invention may be embodied in many different forms and should not be limited to the accompanying drawings. That is, materials for the catalyst and type of the stamp may be varied.

As set forth above, according to exemplary embodiments of the invention, in forming an internal antenna or electromagnetic wave shielding layer of a mobile telecommunication terminal, a plating layer may be formed directly on a plastic base. Moreover, in manufacturing a metal film pattern forming body, the plating layer is easily variable in its shape.

While the present invention has been shown and described in connection with the preferred embodiments, it will be apparent to those skilled in the art that modifications and variations can be made without departing from the spirit and scope of the invention as defined by the appended claims.

What is claimed is:

1. A method of manufacturing a metal film pattern forming body, the method comprising:
forming a desired metal film pattern on one surface of a stamp by using a catalyst for activating a surface of a plastic base;
activating the surface of the plastic base by transferring the catalyst formed on the surface of the stamp onto the surface of the plastic base; and
plating the surface of the activated plastic base.

2. The method of claim 1, wherein the forming a catalyst on a surface of the stamp comprises:
printing the desired metal film pattern with a liquid catalyst;
drying the printed catalyst to have a certain viscosity; and
transferring the dried catalyst pattern onto the stamp.

3. The method of claim 1, wherein the catalyst has a certain viscosity to maintain a desired pattern during the transferring process.

4. The method of claim 1, wherein the catalyst is formed of a material attachable onto the surface of the plastic base where the catalyst is transferred and capable of forming a plating layer on the surface of the plastic base.

5. The method of claim 4, wherein the catalyst is formed of an ABS-based resin.

6. The method of claim 1, wherein the stamp has a certain hardness to be stamped on a three-dimensional surface.

7. The method of claim 1, wherein the stamp is formed of a silicone rubber.

8. The method of claim 1, wherein the plastic base is one of a base of an internal antenna, the base formed of poly carbonate, a carrier film and a case of a mobile telecommunication terminal.

9. The method of claim 1, wherein the plating comprises electroless plating using a copper ion.
